(19) United States
(12) Patent Application Publication
(10) Pub. No.: US 2024/0208350 A1
(43) Pub. Date: Jun. 27, 2024

(54) CHARGING DEVICE

(71) Applicant: TOYOTA JIDOSHA KABUSHIKI KAISHA, Toyota-shi (JP)

(72) Inventors: Kenichi YAMADA, Nisshin-shi (JP); Toshiki KASHIWAKURA, Tokyo (JP); Akane UMEZU, Nagoya-shi (JP); Kayo TSUMOTO, Nisshin-shi (JP); Yuta SHISHIME, Tokyo (JP); Satoshi KOMAMINE, Nagoya-shi (JP); Kenji ISHIYAMA, Kasugai-shi (JP)

(73) Assignee: TOYOTA JIDOSHA KABUSHIKI KAISHA, Toyota-shi (JP)

(21) Appl. No.: 18/498,528

(22) Filed: Oct. 31, 2023

(30) Foreign Application Priority Data
Dec. 23, 2022 (JP) 2022-207189

(51) Int. Cl. B60L 53/38; B60L 53/57; H02J 7/00

(52) U.S. Cl. CPC B60L 53/38; B60L 53/57; H02J 7/0042

(57) ABSTRACT

The charging device of the present disclosure is a charging device capable of autonomous movement for charging a vehicle. The charging device includes a control unit and a moving mechanism. The control unit acquires peripheral information that is information about the surroundings of the vehicle, and determines the arrangement of the charging device with respect to the vehicle being charged based on the peripheral information. The drive mechanism moves the charging device so as to have the above-described arrangement during charging under the control of the control unit.

### CROSS-REFERENCE TO RELATED APPLICATION

This application claims priority to Japanese Patent Application No. 2022-207189 filed on Dec. 23, 2022, incorporated herein by reference in its entirety.

### BACKGROUND

### 1. Technical Field

The present disclosure relates to a self-propelled charging device that charges a vehicle.

### 2. Description of Related Art

A system has been proposed in which a charging service provided by a business operator is reserved when a battery charge amount becomes equal to or less than a predetermined value in a vehicle traveling using electricity as a power source (for example, refer to Japanese Unexamined Patent Application Publication No. 2021-121885 (JP 2021-121885 A)). In the service according to the related art, a power supply vehicle of the business operator goes to a location of a vehicle requiring charging, and a worker of the power supply vehicle inserts a charging plug into a charge port of the vehicle to charge a battery. According to the related art, it is possible to cause a third party to charge the battery of the vehicle even while a user is away from the vehicle.

### SUMMARY

However, in the above-described charging method, it is necessary for the worker of the power supply vehicle to wait in the vicinity of the vehicle being charged until the charging of the vehicle is completed, so that the time of the worker may not be effectively utilized. In order to solve this problem, it is assumed that the size of a charging device is reduced and placed in the vicinity of the vehicle being charged, so that the worker can perform another work in another place even while the one vehicle is charged. However, when the worker leaves the vehicle being charged while the small charging device is placed, the charging device may be stolen.

An object of the present disclosure made in view of such circumstances is to provide a charging device that reduces a risk of theft.

A charging device according to an embodiment of the present disclosure is a charging device that charges a vehicle and that is able to autonomously move, and includes a control unit for acquiring peripheral information that is information of a periphery of the vehicle, and determining an arrangement of the charging device with respect to the vehicle being charged based on the peripheral information; and a moving mechanism that moves the charging device such that the charging device is in the arrangement during charging by control of the control unit.

According to the present disclosure, it is possible to provide the charging device in which the risk of theft is reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic configuration of a charging device according to an embodiment of the present disclosure;

FIG. 2 is a simplified view of the appearance of one form (type A) of the charging device;

FIG. 3 is a diagram for explaining charging of a vehicle using the charging device of FIG. 2;

FIG. 4 is a schematic view of another embodiment (type B) of the charging device;

FIG. 5 is a diagram for explaining charging of vehicles using the charging device of FIG. 4; and

FIG. 6 is a flow chart of a process executed by a charging device.

### DETAILED DESCRIPTION OF EMBODIMENTS

Hereinafter, an embodiment of the present disclosure will be described below with reference to the drawings. Note that the drawings used in the following description are schematic. Dimensions, ratios, and the like in the drawings do not necessarily coincide with actual ones.

### Configuration of the Charging Device

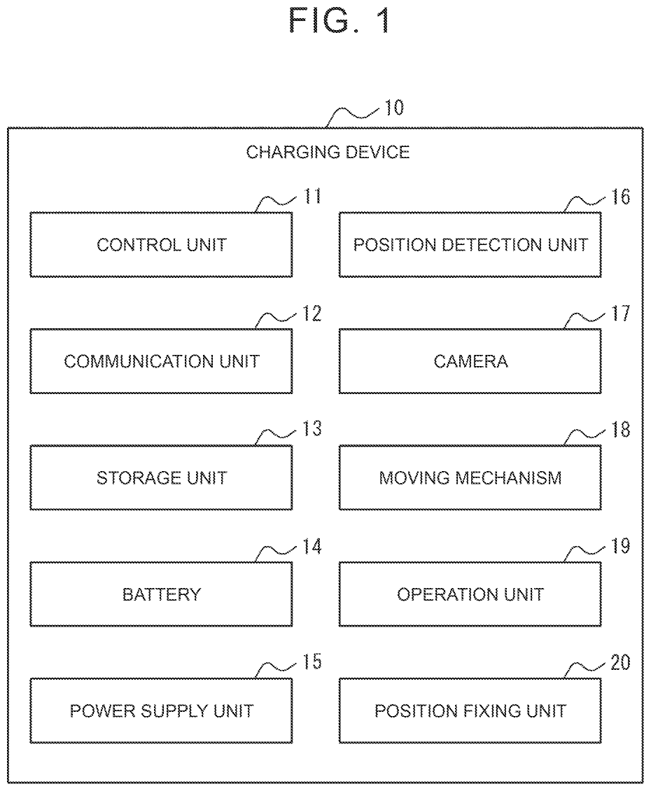

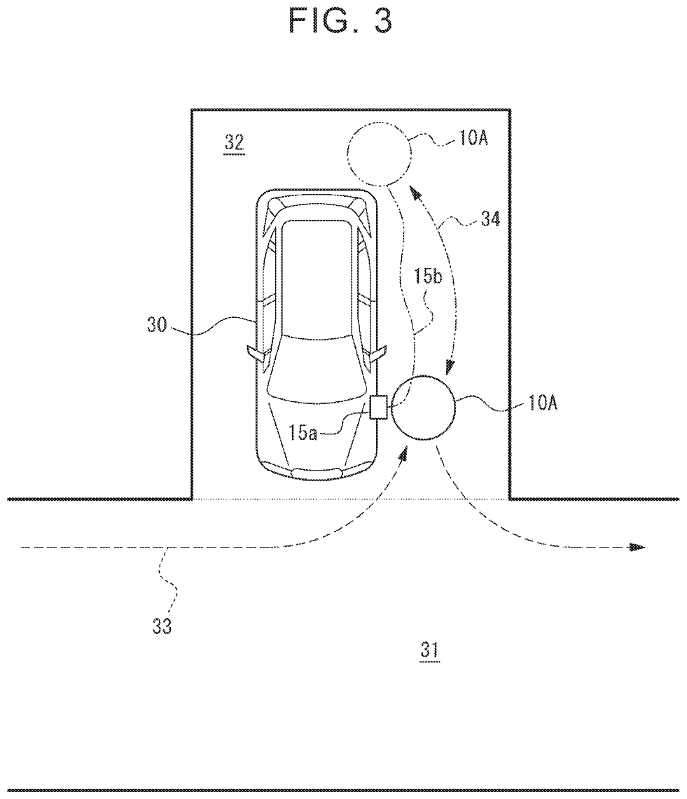

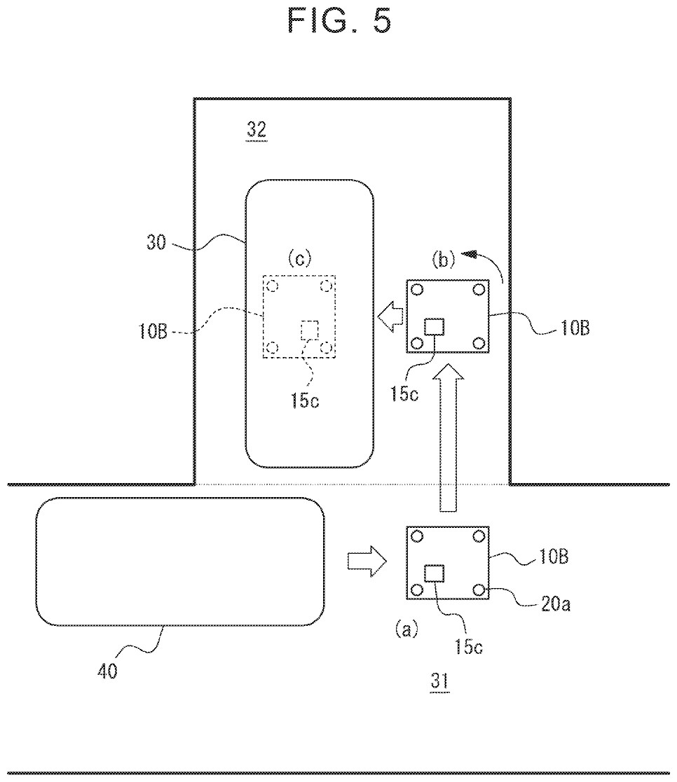

FIG. 1 is a configuration diagram of a charging device 10 that charges a vehicle 30 (see FIGS. 3 and 5) of a user. The vehicles 30 are externally chargeable electrified vehicle including battery electric vehicle (BEV) and plug-in hybrid electric vehicle (PHEV). The charging device 10 receives an instruction from the outside and supplies electric power to the designated vehicle 30. For example, the charging device 10 receives an instruction from the server of the operator that provides the charging service upon receiving a request from the user, and supplies power to the vehicle 30 of the user. The charging device 10 has a function of autonomously moving at least in the vicinity of the vehicle 30. The charging device 10 can acquire peripheral information that is peripheral information and move to a position that is difficult to visually recognize from the outside.

Hereinafter, the configuration of the charging device 10 will be described. The charging device 10 includes a control unit 11, a communication unit 12, a storage unit 13, a battery 14, a power supply unit 15, a position detection unit 16, a camera 17, and a moving mechanism 18. The charging device 10 may include a power generation device in place of the battery 14. The charging device 10 may further include an operation unit 19 and a position fixing unit 20.

The control unit 11 includes at least one processor, at least one dedicated circuit, or a combination thereof. The processor is a general-purpose processor such as a CPU or a GPU, or a dedicated processor specialized for a specific process. The dedicated circuit is, for example, an FPGA or an ASIC. The control unit 11 executes various processes described below for charging the vehicle 30 to be charged by the charging device 10. Part of the processing executed by the control unit 11 may be executed by an external information processing apparatus. The external information processing apparatus is, for example, a server of an operator that provides a charging service. Even when the external information processing apparatus executes a part of the processing of the control unit 11, the control of each unit of the charging device 10 is executed via the control unit 11. For this reason, a process executed by the control unit 11 in cooperation with an external information processing apparatus is regarded as a process executed by the control unit 11.

The communication unit 12 includes at least one external communication interface for connecting to an external information processing device including a server of a business operator providing a charging service, an external device, and a vehicle (for example, a charging device transporting vehicle 40 described later) via a communication network. The external communication interface is, for example, an interface compatible with a mobile communication standard such as LTE, 4G or 5G. For example, the charging device 10 may receive information such as position information, a registration number, a vehicle type, and a color of the vehicle 30 to be charged via the communication unit 12. The charging device 10 may transmit a notification indicating that the charging is completed via the communication unit 12. The communication unit 12 may further include a communication interface for performing short-range wireless communication with the vehicle 30. Near field communication includes NFC (Near Field Communication), Bluetooth, and IrDA (Infrared Data Association).

The storage unit 13 includes one or more memories. The memories are, for example, a semiconductor memory, a magnetic memory, or an optical memory, but are not limited to these memories. The memory or memories included in the storage unit 13 may each function as a main storage, an auxiliary storage, or a cache memory, for example. The storage unit 13 stores arbitrary information used for the operation of the charging device 10. For example, the storage unit 13 may store a program for operating the charging device 10.

The storage unit 13 stores various kinds of information necessary for charging the vehicle 30. For example, the storage unit 13 stores map information including conditions of roads and land around the vehicle 30. Further, the storage unit 13 may store the position of the charging port for each vehicle type of the vehicle 30. The charging port of the vehicle 30 may be disposed at various positions such as an upper portion of the front grille, a front fender, a rear fender, and a rear bumper. Further, the storage unit 13 may store an electronic key for unlocking the cover of the charging port of the vehicle 30. The storage unit 13 may be configured to be capable of sequentially acquiring these pieces of information via the communication unit 12 as necessary.

The battery 14 is a large-capacity storage battery that supplies electric power to a battery mounted on the vehicle 30. The battery 14 includes, for example, a rechargeable secondary battery such as a lithium-ion secondary battery or a nickel-hydrogen secondary battery. The charging device 10 may employ another power storage device such as a multilayer capacitor instead of a secondary battery. The battery 14 includes a capacitor.

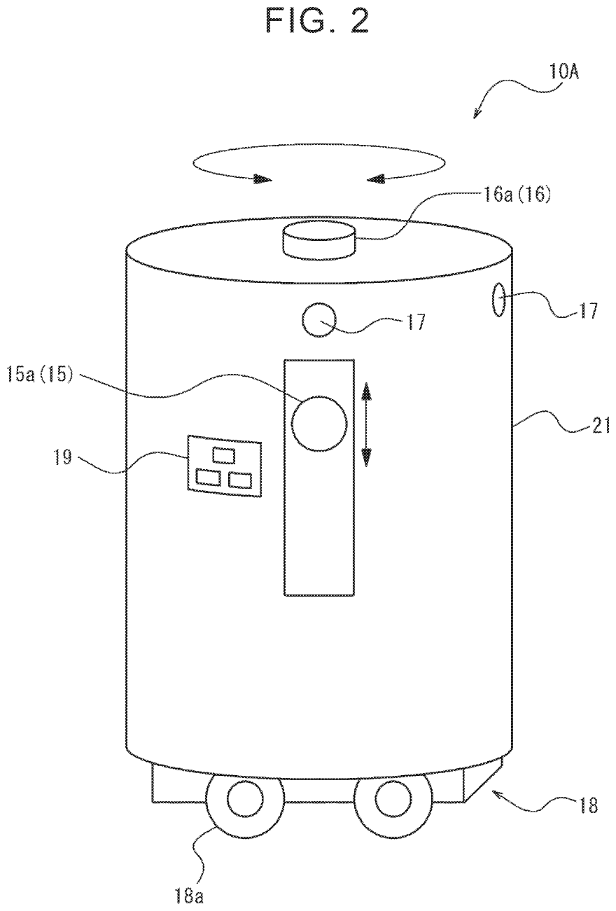

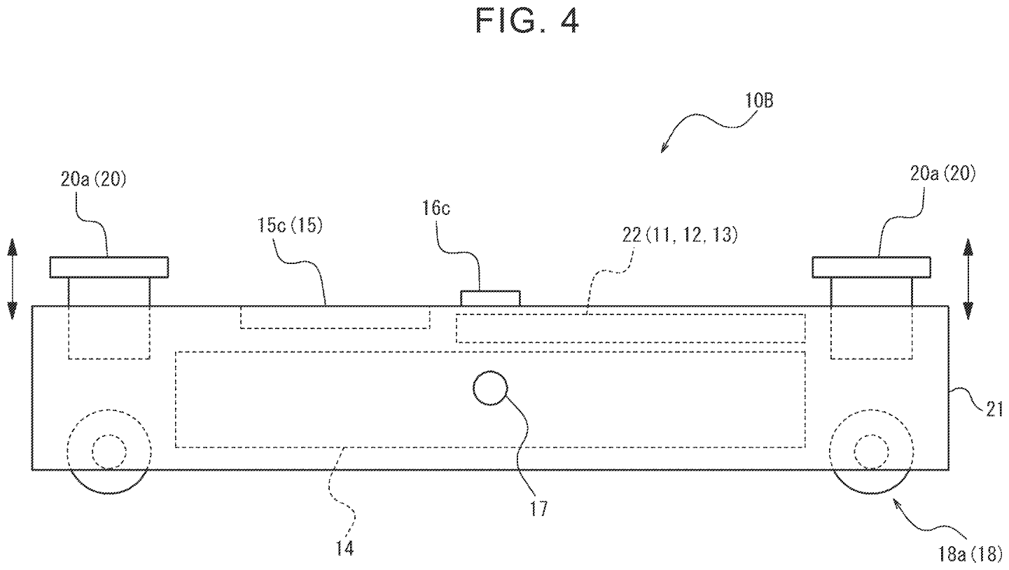

The power supply unit 15 supplies the electric power of the battery 14 to the vehicle 30. The method in which the power supply unit 15 supplies power to the vehicle 30 includes a wired method and a wireless method. For example, when power is supplied by wire, the power supply unit 15 includes a connector 15a and a charging cable 15b (see FIGS. 2 and 3) for connecting to a charging port of the vehicle 30. When power is supplied wirelessly, the power supply unit 15 includes a power supply antenna 15c (see FIGS. 4 and 5) that transmits power to an antenna for power reception (power reception antenna) of the vehicle 30. The method of wirelessly supplying power may be any of an electromagnetic induction method, an electric field coupling method, and an electromagnetic wave method.

The position detection unit 16 detects the position of the charging device 10. The position detection unit 16 includes a Global Positioning System (GPS) receiver. The position detection unit 16 can obtain the latitude and longitude of the present position of the charging device 10 by using the signal from GPS receiver. GPS uses satellites to measure the position of the vehicles 30. Note that a receiver corresponding to another Global Navigation Satellite System (GNSS) may be adopted instead of GPS receiver or in addition to GPS receiver. The position detection unit 16 may further include an orientation sensor to detect the current orientation of the charging device 10. The azimuth sensor includes a geomagnetic sensor that detects geomagnetism and determines an azimuth. The position detection unit 16 can map the position of the charging device 10 on the map information stored in the storage unit 13.

The camera 17 is an imaging device that captures an image of the periphery of the charging device 10. The camera 17 includes an image sensor. The image sensor includes a Charge-Coupled Device Image Sensor (CCD image sensor) and a Complementary MOS Image Sensor (CMOS image sensor). The charging device 10 can mount a plurality of cameras 17. The image captured by the camera 17 is analyzed by the control unit 11. The control unit 11 grasps the surrounding situation including the position of the vehicle 30 from the image captured by the camera 17, the map information stored in the storage unit 13, and the position information acquired from the position detection unit 16. From these pieces of information, the control unit 11 may generate a map in which the arrangement of the road 31 (see FIGS. 3 and 5), the vehicle 30, and the obstacle around the charging device 10 is three-dimensionally grasped.

The peripheral information of the charging device 10 acquired from the image captured by the camera 17 and the map information stored in the storage unit 13 by the charging device 10 is referred to as peripheral information. The charging device 10 may further include an ultrasonic sensor or the like to acquire information of a surrounding obstacle. Such information obtained from the sensor is also included in the surrounding information.

The moving mechanism 18 includes various mechanical and electrical components for the charging device 10 to move. For example, the moving mechanism 18 includes a motor for generating a driving force, a tire 18a for transmitting the driving force to the ground (see FIGS. 2 and 4), a brake for braking the tire 18a, a mechanism for changing the direction of the tire 18a, and the like, and circuits for controlling these components. The moving mechanism 18 moves the entire charging device 10 under the control of the control unit 11.

The operation unit 19 is a manipulator that opens and closes a cover of a charging port of the vehicle 30. The operation unit 19 may have a portion corresponding to a human finger (finger portion) and a portion corresponding to an arm (arm portion). The charging device 10 may be configured to unlock the cover of the charging port to the vehicle 30 by the short-range communication function of the communication unit 12, open the unlocked cover by the operation unit 19, and connect the power supply unit 15 to the charging port of the vehicle 30. When not in use, the operation unit 19 may be accommodated in the housing 21 (see FIG. 2) of the charging device 10. The operation unit 19 is not an essential component. Attachment of the power supply unit 15 of the charging device 10 to the vehicle 30 may be performed by an operator interposed therebetween.

The position fixing unit 20 fixes the charging device 10 during charging with respect to the vehicle 30. The position fixing unit 20 may have any configuration as long as the charging device 10 can be fixed. For example, the position fixing unit 20 may generate a frictional force by pressing both the lower portion of the vehicle 30 and the ground to fix the charging device 10. By fixing the charging device 10 by the position fixing unit 20, the charging device 10 is less likely to be stolen.

### Embodiment of the Charging Device (Type A)

An embodiment of the charging device 10 will be described with reference to FIGS. 2 and 3. The charging device 10A illustrated in FIGS. 2 and 3 autonomously travels to connect the power supply unit 15 to the vehicle 30 to be charged, and moves to a location that is difficult to see from the outside during charging. The charging mode executed by the charging device 10A is referred to as a type-A charging mode.

As illustrated in FIG. 2, the charging device 10A includes a housing 21 and a moving mechanism 18 provided at a lower portion of the housing 21. The housing 21 may be of any shape, including cylindrical or prismatic. A control unit 11, a communication unit 12, a storage unit 13, and a battery 14 are accommodated in the housing 21. In addition, a connector 15a that is the power supply unit 15 is disposed on a part of the side surface of the housing 21. The connector 15a is configured to be movable up and down so as to be connectable to a charging port of the vehicle 30. The connector 15a is initially connected to a charging cable 15b housed in the housing 21. The electric power of the battery 14 is supplied to the charging port of the vehicle 30 through the charging cable 15b and the connector 15a. A GPS receiver 16a that is a part of the position detection unit 16 is disposed in a part of the housing 21. GPS receiver 16a receives radio waves from GPS satellites.

The housing 21 of the charging device 10A is provided with a plurality of cameras 17. The charging device 10A recognizes the surrounding environment on the basis of images captured by the camera 17A, positions detected by the position detection unit 16, and map information stored in the storage unit 13. In one embodiment, the camera 17 may include two cameras 17 arranged in parallel to detect distance. In this case, based on the image output from the two cameras 17, the control unit 11 can detect the distance to the object captured by the camera 17 according to the principle of the stereo camera.

The moving mechanism 18 comprises a tire 18a for running on the ground. The tire 18a can be redirected about a vertical shaft. Thus, the moving mechanism 18 can be turned in addition to the straight movement. Further, the moving mechanism 18 and the housing 21 may be rotatable about an axis perpendicular to each other. The moving mechanism 18 can travel on a designated route under the control of the control unit 11. The control unit 11 controls the moving mechanism 18 based on the map information stored in the storage unit 13, the position information detected by the position detection unit 16, and the image acquired by the camera 17.

The movement of the charging device 10A will be described with reference to FIG. 3. In FIG. 3, the vehicle 30 to be charged is parked in a parking lot 32 facing the road 31. In the present embodiment, the charging device 10A travels through the route 33 on the road 31 to the vicinity of the vehicle 30 by autonomous traveling. It is assumed that the charging device 10A charges the vehicles 30 in the parking lot 32 and further goes to a subsequent charging location.

First, the charging device 10A is moved to the vicinity of the vehicles 30 by the moving mechanisms 18. Next, in order to connect the connector 15a of the power supply unit 15 to the charging port of the vehicle 30, the control unit 11 detects the position of the charging port of the vehicle 30 based on the images captured by the cameras 17. The charging device 10 stops with the power supply unit 15 facing the charging port of the vehicle 30. The position of the charging device 10A indicated by the solid line in FIG. 3 corresponds to this. The control unit 11 can open the cover of the charging port of the vehicle 30 by the operation unit 19 based on images captured by the camera 17, and connect the connector 15a of the power supply unit 15 to the charging port of the vehicle 30. The charging port of the vehicle 30 includes a charging inlet for connecting the connector 15a of the charging cable 15b from the charging device 10.

After the connector 15a of the power supply unit 15 is connected to the charging port of the vehicle 30, the charging device 10A moves through the moving path 34 such that at least a part of the charging device 10 is arranged so as not to be hidden by the vehicle 30 when viewed from the road 31. For example, the charging device 10A moves to a position indicated by a two-dot chain line in FIG. 3. At this time, the charging device 10A extends the charging cable 15b accommodated in the housing 21. In this way, the charging device 10 can reduce the risk of being stolen by moving from the road 31 side to an invisible position.

When the charging of the vehicle 30 is completed, the charging device 10A returns to the position facing the charging port of the vehicle 30 through the moving path 34.

The charging device 10A disconnects the charging port of the vehicle 30 from the power supply unit 15 and moves to a subsequent charging location.

### Embodiment of the Charging Device (Type B)

An embodiment of the charging device 10 will be described with reference to FIGS. 4 and 5. The charging device 10B shown in FIGS. 4 and 5 also penetrates into the underside of the vehicle 30, and charges the power receiving antennae provided on the underside of the vehicle body of the vehicle 30. The charging mode executed by the charging device 10B is referred to as a type-B charging mode.

As shown in FIG. 4, the charging device 10B has a housing 21 that is high enough to enter between the floor of the vehicles 30 and the ground. The height of the housing 21 of the charging device 10B is, for example, 10 cm. The charging device 10B may take any form as long as it is at a height that enters the underfloor of the vehicles 30. However, the charging device 10B is sized to be hidden below the floor of the vehicle 30. In the following explanation, the charging device 10B is a rectangular parallelepiped having a rectangular shape when viewed from above.

The battery 14 and the electronic circuit unit 22 are included in the housing 21 of the charging device 10B. The electronic circuit unit 22 includes a control unit 11, a communication unit 12, and a storage unit 13. Further, on the upper surface of the housing 21, a power supply antenna 15c corresponding to radio power feeding is arranged as the power supply unit 15. The power supply antenna 15c is disposed at a position opposite to the power receiving antenna to which electric power is supplied by the vehicles 30 at the time of charging. Here, the power supply antenna 15c of the charging device 10B may be located offset from the center of the housing 21 in the top view. In other words, the power supply antenna 15c is located eccentrically on the top surface of the charging device 10B. Further, a GPS receiver 16a may be disposed on the upper surface of the housing 21. Further, in the charging device 10B, a plurality of cameras 17 are arranged along the outer periphery of the housing 21.

A moving mechanism 18 including a tire 18a is provided below the housing 21. The tire 18a may each be freely redirected. The tire 18a may be a spherical tire that can move freely by 360 degrees. Preferably, the housing 21 is free to change orientation and move in a free direction by the moving mechanism 18.

Further, the charging device 10B has, as the position fixing unit 20, a lifting member 20a that can move upward and backward from the housing 21. The lifting member 20a may be one or more. The upper portion of the lifting member 20a may be flanged. In the illustrated embodiment, a total of four lifting member 20a are provided at four corners of the housing 21. The charging device 10B may include a motor for operating the lifting member 20a. When the charging device 10B is positioned under the floor of the vehicle 30 and the lifting member 20a is driven upward, the lifting member 20a is stopped at a position in contact with the underfloor of the vehicle body of the vehicle 30 with the underfloor of the vehicle 30 being biased from below. As a result, the charging device 10B pushes the ground by the tire 18a and pushes the underfloor of the vehicle 30 on the upper surface of the lifting member 20a, and is fixed between the ground and the underfloor of the vehicle 30. As described above, since the charging device 10B is fixed to the vehicles and the ground, it is difficult for a third party to steal the charging device 10.

As an example, as illustrated in (a) of FIG. 5, the charging device 10B may be loaded on the charging device transporting vehicle 40 and unloaded from the charging device transporting vehicle 40 around the target charging target vehicle 30.

As illustrated in (b) of FIG. 5, the charging device 10B autonomously travels and moves to the side of the vehicle 30. The charging device 10B collects peripheral data by means of the camera 17. The charging device 10B recognizes the space around the vehicles 30. When the charging device 10B enters the underside of the vehicle 30, the charging device 10B is turned so as to be difficult to see from the outside.

In many cases, the charging device 10B is more likely to be viewed and passed by a third party on the side where it enters the underside of the vehicle 30 (the right side of the vehicle 30 in FIG. 5) because there is more space than on the other side. Therefore, as shown in (c), the control unit 11 of the charging device 10B, when the power supply antenna 15c is opposed to the power receiving antenna of the vehicle side, the charging device 10 of the vehicle 30 from the intruding side of the charging device 10 changes the direction so that it is difficult to see. In FIG. 5, the charging device 10B is redirected to be biased to the left of the vehicle 30.

As described above, the control unit 11 of the charging device 10B determines the arrangement of the charging device 10B so that the charging device 10B is in a direction that is difficult to see from the surroundings of the vehicles 30. By doing so, the possibility that the charging device 10B is stolen is reduced because the charging device 10B is less likely to enter the field of view of the third party.

When charging the vehicles 30, the charging device 10B can perform charging by driving the lifting member 20a upward to fix the position as described above. Further, when the charging is terminated, the charging device 10B may transmit, as it is, a signal indicating the termination of the charging from the communication unit 12 to the servers of the businesses providing the charging service. In this situation, the charging device transporting vehicles 40 are dispatched in order to recover the charging device 10B from the operator. When the charging device transporting vehicle 40 arrives in the vicinity of the vehicle 30, in response to a notification from the charging device transporting vehicle 40, the charging device 10B may release the position fixing by the lifting member 20a and autonomously move to the vicinity of the charging device transporting vehicle 40 on the road 31.

### Charging Method for a Charging Device

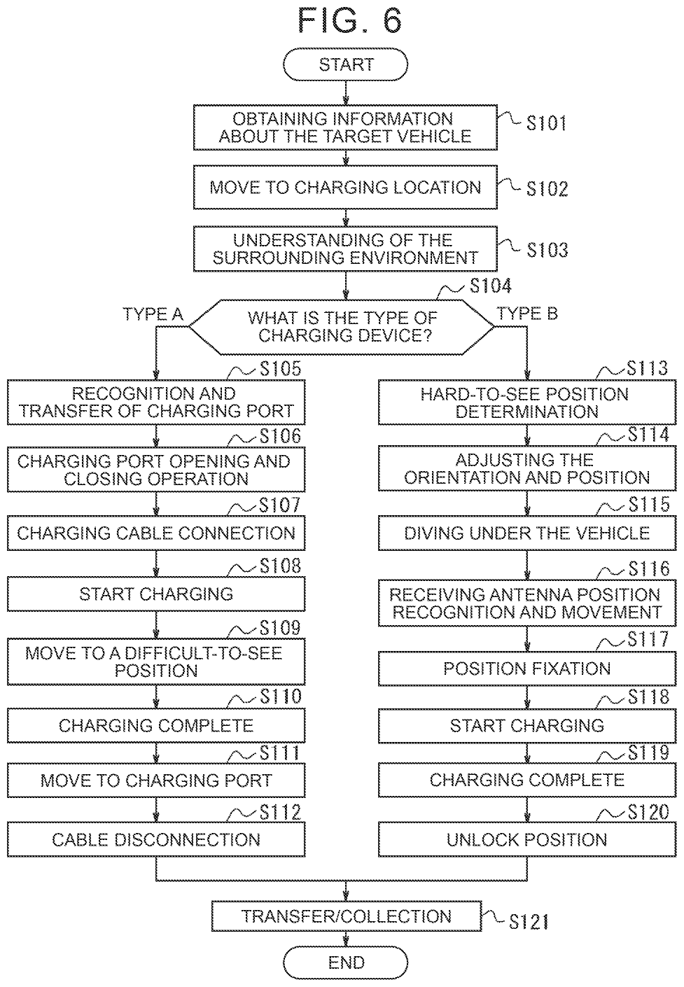

A method of charging the vehicle 30 by the charging device 10 will be described with reference to the flowchart of FIG. 6. The method disclosed in this specification may be executed by a processor included in the control unit 11 according to a program. Such a program can be stored in a non-transitory computer-readable medium. Non-transitory computer-readable media include, but are not limited to, hard disks, Random Access Memory (RAM), Read Only Memory (ROM), flash memories, Compact Disc Read only memory (CD-ROM), optical storage devices, magnetic storage devices, and the like.

First, the charging device 10 acquires information of the vehicle 30 to be charged (S101). The charging device 10 can acquire the information of the vehicle 30 to be charged from the server of the provider providing the charging service. The information of the vehicle 30 to be charged includes, for example, position information of the vehicle 30 or the parking lot 32 thereof, a registration number of the vehicle 30, a vehicle type, and color information.

The charging device 10 having acquired the information moves to the charging location of the vehicle 30. Here, depending on the function and performance of the moving mechanism 18 included in the charging device 10, the charging device 10 may travel on the road 31 for a certain distance to move to the charging location, and may be transported to the vicinity of the charging location by the charging device transporting vehicle 40 driven by the worker (S102).

The charging device 10 that has moved to the charging location acquires the peripheral information using the camera 17 and grasps the peripheral environment (S103). The charging device 10 may generate a map of the surroundings of the vehicle 30 including the vehicle 30, an obstacle, and the like based on the surroundings information. At this time, the charging device 10 may recognize the registration number, the vehicle type, the color, and the like of the vehicle 30 and confirm that the vehicle 30 is the vehicle for which registration is requested.

Subsequent processes differ depending on the types of the charging device 10 (S104). When the type of the charging device 10 is the type A described above, the control unit 11 of the charging device 10 executes S105 to S112 process. When the type of the charging device 10 is the type B described above, the control unit 11 of the charging device 10 executes S113 to S120 process.

In the case of the type-A charging device 10A, the charging device 10A recognizes the charging port of the vehicle 30 and moves to the position of the power receiving port (S105). The charging device 10A knows the approximate position of the charging port from the information on the vehicle type of the vehicle 30 and the information on the charging port for each vehicle type stored in the storage unit 113. Further, the charging device 10A can accurately recognize the position of the charging port by image recognition from the image acquired by the camera 17.

For example, the charging device 10A causes the vehicles 30 to unlock the charging port by short-range communication, and causes the operation unit 19 to open the covering of the charging port (S106). The charging device 10A may unlock the charging port by transmitting an electronic key acquired in advance to the vehicles 30.

Subsequently, the charging device 10A connects the connector 15a at the front end of the charging cable 15b to the charging port of the vehicle 30 (S107). Connection of the connector 15a to the charging port of the vehicle 30 may have a function of the power supply unit 15 to align and connect the connector 15a to the charging port. Alternatively, the connector 15a may be connected to the charging port by the operation unit 19. S107 may be performed by an operator.

When the charging cable 15b is connected to the charging port of the vehicle 30, the charging device 10A starts charging the vehicle 30 from the battery 14 (S108).

When charging is started, the charging device 10A autonomously moves to a position that is difficult to see from the road 31 (S109). At this time, the charging device 10A and the vehicles 30 are connected by a charging cable 15b. The position that is difficult to see from the road 31 side is, for example, a position that is a rear side of the vehicle 30 when viewed from the road 31 side. At least a part of the charging device 10A is hidden from the vehicles 30 and is difficult to see.

The charging device 10A continues charging at a position difficult to see from the road 31. After an appropriate period, the charging of the vehicles 30 by the charging device 10A is ended (S110).

When the charging is completed, the charging device 10A moves to the position of the power supply port of the vehicle 30 (S111).

The charging device 10A disconnects the connector 15a from the charging port of the vehicle 30 and disconnects the power supply unit 15 from the charging port of the vehicle 30 (S112).

On the other hand, in the charging device 10B of the type-B, the charging device 10B determines a position that is difficult to see after the surrounding environment is grasped by S103 (S113). The difficult-to-see position in this case means a position which is difficult to be seen from the outside on the lower side of the vehicle 30. At this time, the arrangement of the charging device 10B with respect to the vehicle 30 is determined by considering the position of the power supply antenna 15c of the charging device 10B and the position of the power receiving antenna of the vehicle 30.

The charging device 10B will S114 the orientation and position so that it will be a less visible position when it is caught underneath the vehicles 30.

The charging device 10B, in particular, rotates in a horizontal plane to adjust its orientation and then S115 it down the vehicles.

The charging device 10B recognizes the position of the power receiving antenna of the vehicle 30, and moves and adjusts the position of the power receiving antenna so that the power supply antenna 15c opposes the power receiving antenna (S116). The charging device 10B may further include an upwardly facing camera 17 in the vicinity of the power supply antenna 15c to recognize the position of the power receiving antenna of the vehicle 30 by image-recognition. The method of recognizing the position of the power receiving antenna is not limited to the method of image processing. For example, the charging device 10B may detect the position of the receiving antennae by electric or magnetic methods.

Next, although not essential, the charging device 10B fixes the position of the charging device 10B by driving the lifting member 20a upward so as to be in contact with the lower surface of the vehicle body of the vehicle 30. Since the charging device 10B presses both the ground and the underside of the vehicle 30, it is difficult to move due to the same principles as the stick bar.

The charging device 10B starts charging while the power supply antenna 15c is positioned on the power receiving antenna of the vehicle 30 (S118).

After the charging starts, the charging of the vehicles 30 ends after an appropriate period (S119).

When the charging is completed, if the position is fixed by S117, the charging device 10B releases the position fixing at an appropriate timing (S120). The charging device 10B may release the position fixation after the charging device transporting vehicles 40 arrive at a subsequent S121 instead of immediately after the charging is completed.

After the completion of S112 and after the completion of S120, the charging device 10 moves to the next target location by autonomous traveling, or moves to the road 31 and is collected by the charging device carrying vehicle 40 (S121).

As described above, according to the charging device 10 of the present disclosure, since the charging device 10 is moved so that the control unit 11 is arranged so as to be less likely to be stolen during charging, the risk of being stolen by a third party can be reduced. Further, since the charging device 10 can autonomously move, it is possible to greatly save the time and effort of the worker involved in transporting, attaching, detaching, and the like of the charging device.

The type-A charging device 10A moves such that at least a portion of the charging device is hidden from the vehicle 30 when viewed from the roadside, so that the danger of theft by a third party is reduced. Note that the type-A charging device 10A may also include a position fixing unit 20 that fixes the position with respect to the vehicles 30. The risk of theft of the charging device 10A is then further reduced.

Since the type-B charging device 10B is located below the vehicles 30 during charging, it is difficult to see from the outside and is difficult to be stolen. In addition, in the type-B charging device 10B, since the direction of the charging device 10B can be set to be a direction that is difficult to see from the surroundings below the vehicles 30, the risk of theft is further reduced. Furthermore, since the type-B charging device 10B can fix the position of the charging device 10B with respect to the vehicle 30 by the position fixing unit 20, it is difficult for a third party to take away the charging device 10B being charged. Therefore, the possibility of the charging device 10B being stolen by a third party is further reduced.

It should be noted that the present disclosure is not limited to the above-described embodiments, and many modifications and variations are possible. For example, the functions included in each means, each step, etc. can be rearranged so as not to be logically inconsistent, and a plurality of means, steps, etc. can be combined into one or divided.

Although two embodiments (type A and type B) have been described herein, the charging device of the present disclosure may be implemented in various other forms. For example, the charging device may be shaped such that only a part of the charging device enters the lower side of the vehicle and the other part is located on the side surface of the vehicle.

What is claimed is:

1. A charging device that charges a vehicle and is able to autonomously move, the charging device comprising:
a control unit for acquiring peripheral information that is information of a periphery of the vehicle, and determining an arrangement of the charging device with respect to the vehicle being charged based on the peripheral information; and
a moving mechanism that moves the charging device such that the charging device is in the arrangement during charging by control of the control unit.

2. The charging device according to claim 1, wherein when the vehicle is parked in a location facing a road, the arrangement of the charging device is an arrangement in which at least a portion of the charging device is hidden from the vehicle when viewed from the road.

3. The charging device according to claim 1, wherein the arrangement of the charging device is an arrangement in which the charging device enters under the vehicle.

4. The charging device according to claim 3, wherein the control unit determines the arrangement of the charging device such that an orientation of the charging device is an orientation that is difficult to see from surroundings of the vehicle.

5. The charging device according to claim 3, further comprising a position fixing unit for fixing a position of the charging device with respect to the vehicle.
